(19) United States
(12) Patent Application Publication
(10) Pub. No.: US 2026/0159027 A1
(43) Pub. Date: Jun. 11, 2026

(54) VEHICLE ANTI-THEFT SYSTEM AND VEHICLE ANTI-THEFT METHOD

(71) Applicant: Wistron NeWeb Corporation, Hsinchu (TW)

(72) Inventor: I-Kun CHAN, Hsinchu (TW)

(21) Appl. No.: 19/207,459

(22) Filed: May 14, 2025

(30) Foreign Application Priority Data
Dec. 5, 2024 (TW) 113147298

(51) Int. Cl. B60R 25/102; B60R 25/30; B60R 25/31; B60R 25/33; G06V 20/58; G06V 40/10

(52) U.S. Cl. CPC B60R 25/102; B60R 25/305; B60R 25/31; B60R 25/33; G06V 20/58; G06V 40/10; B60R 2325/101

(57) ABSTRACT

A vehicle anti-theft system includes a vehicle and a cloud monitoring center. The vehicle includes a tracker and a photographing device. The tracker includes a positioning module and a tracking processor. The positioning module is configured to generate a plurality of positioning coordinates. The tracking processor stores an electronic fence coordinate area. The tracking processor judges if the vehicle is in a safe area or in a warning area. When the vehicle is outside the electronic fence coordinate area, the vehicle is in the warning area. The photographing device includes a photographing processor and a camera. When the tracker judges the vehicle is in the warning area, the photographing processor judges if the vehicle is in a warning status or a safe status. The cloud monitoring center receives the positioning coordinates.

### RELATED APPLICATIONS

This application claims the benefit of priority to Taiwan Patent Application No. 113147298, filed on Dec. 5, 2024. The entire content of the above identified application is incorporated herein by reference.

### BACKGROUND

### Technical Field

The present disclosure relates to an anti-theft system and an anti-theft method, in particular to a vehicle anti-theft system and a vehicle anti-theft method.

### Description of Related Art

With the prosperity of commercial trade, the demand for cargo transportation has significantly increased. Among various transportation methods, vehicle transportation remains one of the primary methods.

However, vehicles may carry high-value cargo and travel long distances, making them vulnerable to being targeted by criminal groups, potentially resulting in property loss. To address this issue, related industries have installed anti-theft systems on vehicles, typically using vibration sensors. When a vehicle is stolen, vibrations are detected, triggering the anti-theft system to emit an alarm sound. However, such conventional anti-theft systems are susceptible to the sensitivity of the sensors, often causing false alarms or failing to activate the alarm system due to human error. Moreover, in remote or sparsely populated areas, the alarm sound may not attract attention, leaving room for improvement.

### SUMMARY

According to one aspect of the present disclosure, a vehicle anti-theft system is provided. The vehicle anti-theft system includes a vehicle and a cloud monitoring center. The vehicle includes a tracker and a photographing device. The tracker includes a positioning module and a tracking processor. The positioning module is configured to generate a plurality of positioning coordinates. The tracking processor is signal-connected to the positioning module and configured to store an electronic fence coordinate area. The tracking processor compares the positioning coordinates with the electronic fence coordinate area to determine whether the vehicle is in a safe area or a warning area. The tracking processor determines that the vehicle is in the safe area when the vehicle is within the electronic fence coordinate area, and determines that the vehicle is in the warning area when the vehicle is outside the electronic fence coordinate area. The photographing device includes a photographing processor and a camera. The photographing processor is signal-connected to the tracking processor. The camera is signal-connected to the photographing processor and is configured to obtain at least one of an image and a sound. The cloud monitoring center is signal-connected to the tracking processor and configured to receive the positioning coordinates. When the tracking processor determines that the vehicle is in the warning area, the tracking processor notifies the photographing processor, the photographing processor causes the camera to obtain at least one of the image and the sound. The photographing processor determines whether the vehicle is in a warning state or a safe state based on at least one of the image and the sound.

According to another aspect of the present disclosure, a vehicle anti-theft method is provided. The vehicle anti-theft method includes an initial tracking step, a detecting step, and an uploading step. The initial tracking step in which a vehicle anti-theft system generates a plurality of positioning coordinates. The vehicle anti-theft system includes a vehicle and a cloud monitoring center. The vehicle includes a tracker and a photographing device. The tracker includes a positioning module and a tracking processor. The positioning module is configured to generate the positioning coordinates. The tracking processor is signal-connected to the positioning module and stores an electronic fence coordinate area. The tracking processor compares the positioning coordinates with the electronic fence coordinate area to determine whether the vehicle is in a safe area or a warning area. The tracking processor determines that the vehicle is in the safe area when the vehicle is within the electronic fence coordinate area, and determines that the vehicle is in the warning area when the vehicle is outside the electronic fence coordinate area. The photographing device includes a photographing processor and a camera. The photographing processor is signal-connected to the tracking processor, and the camera is signal-connected to the photographing processor and configured to obtain at least one of an image and a sound. The cloud monitoring center is signal-connected to the tracking processor and configured to receive the positioning coordinates. The detecting step in which when the tracking processor determines that the vehicle is in the warning area, the tracking processor notifies the photographing processor. The photographing processor causes the camera to obtain at least one of the image and the sound. The photographing processor determines whether the vehicle is in a warning state or a safe state based on at least one of the image and the sound. The uploading step in which the photographing processor determines whether the vehicle is in the warning state based on at least one of the image and the sound, and the tracking processor uploads at least one of the image and the sound to the cloud monitoring center.

### BRIEF DESCRIPTION OF THE DRAWINGS

The present disclosure can be more fully understood by reading the following detailed description of the embodiment, with reference made to the accompanying drawings as follows:

FIG. 1 illustrates a system diagram of a vehicle anti-theft system according to one embodiment of the present disclosure.

FIG. 2 illustrates a block flowchart of a vehicle anti-theft method according to another embodiment of the present disclosure.

FIG. 3 illustrates a step flowchart of the vehicle anti-theft method of the embodiment shown in FIG. 2.

### DETAILED DESCRIPTION

The present disclosure is more particularly described in the following embodiments that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an” and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

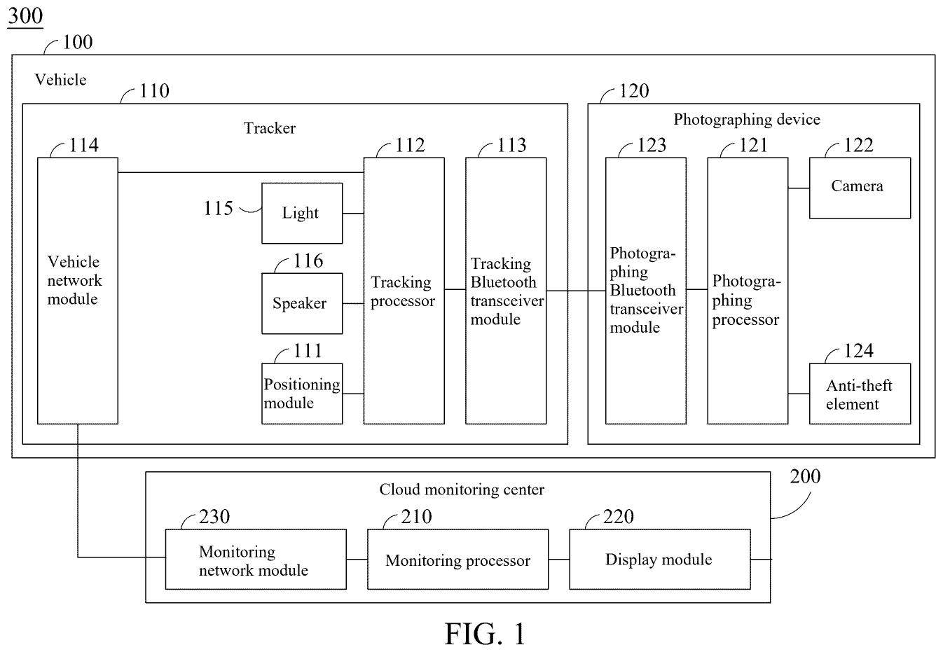

Please refer to FIG. 1, which illustrates a system diagram of a vehicle anti-theft system 300 according to one embodiment of the present disclosure. The vehicle anti-theft system 300 includes a vehicle 100 and a cloud monitoring center 200. The vehicle 100 includes a tracker 110 and a photographing device 120. The tracker 110 includes a positioning module 111 and a tracking processor 112. The positioning module 111 is configured to generate a plurality of positioning coordinates. The tracking processor 112 is signal-connected to the positioning module 111 and stores an electronic fence coordinate area. The tracking processor 112 compares the positioning coordinates with the electronic fence coordinate area to determine whether the vehicle 100 is located in a safe area or a warning area. When the vehicle 100 is within the electronic fence coordinate area, it is determined that the vehicle 100 is in the safe area. When the vehicle 100 is outside the electronic fence coordinate area, it is determined that the vehicle 100 is in the warning area. The photographing device 120 includes a photographing processor 121 and a camera 122. The photographing processor 121 is signal-connected to the tracking processor 112. The camera 122 is signal-connected to the photographing processor 121 and is configured to obtain at least one of an image and a sound. The cloud monitoring center 200 is signal-connected to the tracking processor 112 and is configured to receive the positioning coordinates. When the tracking processor 112 determines that the vehicle 100 is in the warning area, the tracking processor 112 notifies the photographing processor 121. The photographing processor 121 causes the camera 122 to obtain at least one of the image and the sound. The photographing processor 121 determines whether the vehicle 100 is in a warning state or a safe state based on at least one of the image and the sound.

Thus, by tracking the position of the vehicle 100 through the positioning module 111 and monitoring the vehicle 100 with the photographing device 120, the possibility of vehicle theft can be reduced.

Specifically, the tracker 110 can be installed in a front area of the vehicle 100, and the vehicle anti-theft system 300 can store the electronic fence coordinate area through the tracking processor 112. In the present embodiment, the electronic fence coordinate area can include the departure location and destination of the vehicle 100, it defines a coordinate range that is referred to as the electronic fence coordinate area. When the vehicle 100 is at the departure location or destination, manual loading and unloading may frequently trigger the vehicle anti-theft system 300. Therefore, the coordinate range of the departure location and destination is set as the electronic fence coordinate area. The departure location and destination may, for example, be ports.

The positioning module 111 includes a GPS receiving unit (not shown), which is signal-connected to the tracking processor 112 and generates positioning coordinates. Specifically, the GPS receiving unit of the positioning module 111 can receive signals from GPS satellites, thereby generating the positioning coordinates of the vehicle 100 and transmitting the positioning coordinates to the tracking processor 112. In the present embodiment, the tracking processor 112 can further transmit the positioning coordinates to the cloud monitoring center 200, helping the cloud monitoring center 200 to keep track of the vehicle 100's position in real-time.

The tracking processor 112 stores the electronic fence coordinate area and receives positioning coordinates from the positioning module 111. The tracking processor 112 compares the positioning coordinates with the electronic fence coordinate area. When the vehicle 100 is within the electronic fence coordinate area, it indicates that the vehicle 100 may still be in the process of loading or unloading, and the tracking processor 112 determines that the vehicle 100 is in a safe area with no risk of theft, thereby eliminating the need to activate the camera 122. When the vehicle 100 is outside the electronic fence coordinate area, it indicates that the vehicle 100 has left the departure location but has not yet reached the destination. The tracking processor 112 determines that the vehicle 100 is in a warning area and may be at risk of theft, thereby requiring monitoring through the camera 122. Therefore, the tracking processor 112 notifies the photographing processor 121 to activate the camera 122 for monitoring.

The tracker 110 can further include a light 115 and a speaker 116, both of which are connected to the tracking processor 112. In the present embodiment, the warning effect can be achieved by activating the light 115 and the speaker 116.

The tracker 110 can further include a vehicle network module 114, which is signal-connected to the tracking processor 112 and can connect to the internet. The tracking processor 112 can transmit positioning coordinates or other signals to the cloud monitoring center 200 through the vehicle network module 114. The vehicle network module 114 may utilize a mobile communication network (such as at least one of 2G, 3G, 4G, or 5G) for wireless communication, but is not limited thereto.

The photographing device 120 can further include a photographing Bluetooth transceiver module 123, which is connected to the photographing processor 121. The tracker 110 can further include a tracking Bluetooth transceiver module 113, which is connected to the tracking processor 112. The photographing Bluetooth transceiver module 123 is signal-connected to the tracking Bluetooth transceiver module 113 to achieve wireless transmission.

Specifically, the tracking processor 112 can transmit or receive messages through the tracking Bluetooth transceiver module 113, while the photographing processor 121 can transmit or receive messages through the photographing Bluetooth transceiver module 123. The tracking processor 112 and the photographing processor 121 can respectively achieve wireless transmission through the tracking Bluetooth transceiver module 113 and the photographing Bluetooth transceiver module 123. When the vehicle 100 is in the warning area, the tracking processor 112 sends a command to activate the camera 122 through the tracking Bluetooth transceiver module 113. The photographing processor 121 receives the activation command through the photographing Bluetooth transceiver module 123 and then activates the camera 122.

The photographing processor 121 can include a recognition unit (not shown), which is configured to analyze the image and determine whether the image contains a human figure. If the image contains a human figure, the photographing processor 121 determines that the vehicle 100 is in a warning state. The photographing processor 121 uploads the image to the cloud monitoring center 200 through the tracking processor 112.

The camera 122 may be installed inside the vehicle 100, specifically positioned at the rear area where cargo is stored. The camera 122 captures images or sounds within the vehicle 100 and transmits them to the photographing processor 121. The recognition unit of the photographing processor 121 is configured to analyze the image or sound to determine whether there is any abnormality in the vehicle 100. In particular, the recognition unit can utilize artificial intelligence (AI) to analyze and determine whether the image contains a human figure. If the image contains a human figure, it indicates that the vehicle 100 may have been intruded, and the photographing processor 121 determines that the vehicle 100 is in a warning state. The photographing processor 121 then transmits the image or sound to the tracking processor 112, which subsequently transmits the image or sound to the cloud monitoring center 200 through the vehicle network module 114. On the other hand, if no human figure is detected, it indicates that there is no intrusion and the vehicle is in a safe state. In the present embodiment, the photographing device 120 can include a battery, which supplies power to the camera 122. Additionally, the camera 122 can be an infrared camera, capable of performing photography in low-light environments, thereby assisting in capturing clearer images.

The photographing device 120 can further include an anti-theft element 124, which is signal-connected to the photographing processor 121. In the present embodiment, the anti-theft element 124 can be a speaker, and the photographing processor 121 can store pre-recorded warning messages to achieve a warning effect by playing the messages through the anti-theft element 124.

The cloud monitoring center 200 can include a monitoring processor 210 and a display module 220. The monitoring processor 210 is signal-connected to the tracking processor 112, and the display module 220 is signal-connected to the monitoring processor 210 to display images.

Specifically, the cloud monitoring center 200 can further include a monitoring network module 230, which is signal-connected to the monitoring processor 210. The monitoring network module 230 can receive data from the vehicle network module 114. In the present embodiment, the data from the vehicle network module 114 can include positioning coordinates and images, but is not limited thereto.

The vehicle anti-theft system 300 can further include a communication device (not shown). The display module 220 is configured to enable a monitoring personnel to verify whether the image indeed contains a human figure. If the presence of a human figure is confirmed, the monitoring personnel uses the communication device to notify a driver.

Specifically, when the monitoring processor 210 receives the image from the vehicle network module 114 through the monitoring network module 230, the monitoring processor 210 displays the image in real-time on the display module 220. The monitoring personnel can reconfirm whether the image contains the human figure, thereby avoiding the possibility of misjudging the vehicle 100 as being in a warning state or a safe state due to erroneous recognition by the photographing processor 121. If the monitoring personnel confirm that the image does indeed contain the human figure, the monitoring personnel use the communication device to notify the driver that the vehicle 100 is in the warning state and request the driver to assist in verifying the status of the vehicle 100.

If the driver does not respond or reports an abnormal condition, the cloud monitoring center 200 determines that the vehicle 100 is in a dangerous state. The tracking processor 112 notifies the photographing processor 121 to activate the anti-theft element 124. When the cloud monitoring center 200 determines that the vehicle 100 is in a dangerous state, the monitoring processor 210 generates commands to activate the light 115, the speaker 116, and the anti-theft element 124. The monitoring processor 210 sends the commands to activate the light 115 and the speaker 116 to the tracking processor 112, which then activates the light 115 and the speaker 116. The monitoring processor 210 also transmits the command to activate the anti-theft element 124 through the tracker 110 to the photographing processor 121 of the photographing device 120, which activates the anti-theft element 124. Thus, the warning effect is achieved through the light 115, the speaker 116, and the anti-theft element 124.

When the cloud monitoring center 200 determines that the vehicle 100 is in a dangerous state, the communication device of the vehicle anti-theft system 300 can be used by the monitoring personnel to notify the police and transmit the positioning coordinates to the police. In addition to activating the light 115, the speaker 116, and the anti-theft element 124, the monitoring personnel may also use the communication device to inform the police and provide the positioning coordinates simultaneously, thereby collaborating with the police in real-time to protect the vehicle 100 from theft.

When the cloud monitoring center 200 determines that the vehicle 100 is in the safe state or the warning state, the tracking processor 112 can report the positioning coordinates to the monitoring processor 210 at a first frequency. When the vehicle 100 is in a dangerous state, the tracking processor 112 can report the positioning coordinates to the monitoring processor 210 at a second frequency in which the first frequency is lower than the second frequency.

Specifically, the tracking processor 112 can report positioning coordinates to the monitoring processor 210 of the cloud monitoring center 200 at different frequencies. When the vehicle 100 is within the electronic fence coordinate area, the tracking processor 112 determines that the vehicle 100 is in the safe area. Alternatively, even if the vehicle 100 is outside the electronic fence coordinate area, if the recognition unit of the photographing processor 121 determines that the image does not contain the human figure, it is still considered to be in the safe state. In this case, there is no need to frequently update the positioning coordinates, and thus the tracking processor 112 can report the positioning coordinates to the monitoring processor 210 at the first frequency. When the vehicle 100 is outside the electronic fence coordinate area and the recognition unit of the photographing processor 121 determines that the image contains the human figure, since the driver's confirmation of the vehicle 100 status has not been obtained, the tracking processor 112 determines that the vehicle 100 is in the warning state and reports the positioning coordinates to the monitoring processor 210 at the first frequency. When the vehicle 100 is in the warning state, the monitoring personnel attempt to confirm the vehicle 100 status with the driver. If the driver does not respond or reports an abnormal condition, the cloud monitoring center 200 determines that the vehicle 100 is in the dangerous state, indicating a potential theft risk. Therefore, the tracking processor 112 reports the positioning coordinates to the monitoring processor 210 at the second frequency, which is higher than the first frequency, enabling the cloud monitoring center 200 and the police to more accurately track the position of the vehicle 100.

It should be noted that the tracking processor 112, the photographing processor 121, and the monitoring processor 210 in the present embodiment may, for example, be a central processing unit (CPU), or other programmable general-purpose or special-purpose micro control units (MCU), microprocessors, digital signal processors (DSP), programmable logic controllers (PLC), application-specific integrated circuits (ASIC), graphics processing units (GPU), arithmetic logic units (ALU), complex programmable logic devices (CPLD), field-programmable gate arrays (FPGA), or other similar components or combinations of the above components, but are not limited thereto.

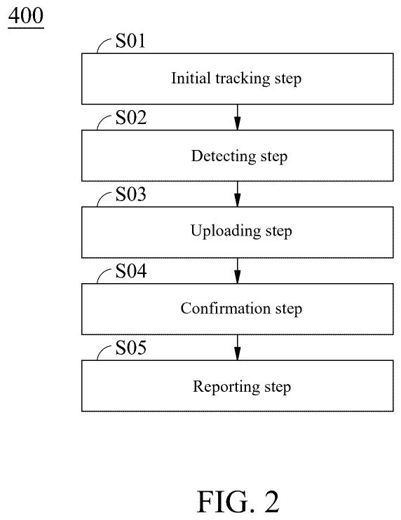

Please refer to FIG. 2, which illustrates a block flowchart of a vehicle anti-theft method 400 according to another embodiment of the present disclosure. The vehicle anti-theft method 400 includes an initial tracking step S01, a detecting step S02, and an uploading step S03. The following will describe the details of the vehicle anti-theft method 400 in conjunction with the vehicle anti-theft system 300 shown in FIG. 1.

In the initial tracking step S01, the vehicle anti-theft system 300 generates a plurality of positioning coordinates. The vehicle anti-theft system 300 includes a vehicle 100 and a cloud monitoring center 200. The vehicle 100 includes a tracker 110 and a photographing device 120. The tracker 110 includes a positioning module 111 and a tracking processor 112. The positioning module 111 is configured to generate the positioning coordinates, particularly through the GPS receiving unit of the positioning module 111. The tracking processor 112 is signal-connected to the positioning module 111 and stores an electronic fence coordinate area. The tracking processor 112 compares the positioning coordinates with the electronic fence coordinate area to determine whether the vehicle 100 is in a safe area or a warning area. When the vehicle 100 is within the electronic fence coordinate area, it is determined to be in the safe area. When the vehicle 100 is outside the electronic fence coordinate area, it is determined to be in the warning area. The photographing device 120 includes a photographing processor 121 and a camera 122. The photographing processor 121 is signal-connected to the tracking processor 112, and the camera 122 is signal-connected to the photographing processor 121 to obtain at least one of an image and a sound. The cloud monitoring center 200 is signal-connected to the tracking processor 112 to receive the positioning coordinates.

In the detecting step S02, when the tracking processor 112 determines that the vehicle 100 is in the warning area, the tracking processor 112 notifies the photographing processor 121. The photographing processor 121 causes the camera 122 to obtain at least one of the image and the sound. The photographing processor 121 determines whether the vehicle 100 is in the warning state or the safe state based on at least one of the image and the sound. Specifically, the recognition unit may analyze the image to determine whether it contains a human figure. If the human figure is detected, the photographing processor 121 determines that the vehicle 100 is in the warning state. If no human figure is detected, the photographing processor 121 determines that the vehicle 100 is in the safe state.

In the uploading step S03, the photographing processor 121 determines whether the vehicle 100 is in the warning state based on at least one of the image and the sound. The tracking processor 112 uploads at least one of the image and the sound to the cloud monitoring center 200. In the present embodiment, the photographing processor 121 transmits the image through the photographing Bluetooth transceiver module 123, and the tracking processor 112 receives the image through the tracking Bluetooth transceiver module 113. The tracking processor 112 then uploads the image to the cloud monitoring center 200 through the vehicle network module 114. It should be noted that the tracking processor 112 can also upload the positioning coordinates to the cloud monitoring center 200 through the vehicle network module 114 simultaneously, allowing the monitoring personnel to track the position of the vehicle 100.

The vehicle anti-theft method 400 can further include a confirmation step S04. In the confirmation step S04, the display module 220 displays the image for verification by the monitoring personnel. The monitoring personnel verify whether the image indeed contains the human figure. If the presence of the human figure is confirmed, the monitoring personnel notify the driver. If the driver does not respond or reports an abnormal condition, the cloud monitoring center 200 determines that the vehicle 100 is in a dangerous state. The tracking processor 112 activates the speaker 116 and the light 115 and notifies the photographing processor 121 to activate the anti-theft element 124. Additionally, when the vehicle 100 is in the dangerous state, the tracking processor 112 reports the positioning coordinates at a second frequency, which is higher than a first frequency, during the uploading step S03. If the driver reports no abnormality, the cloud monitoring center 200 determines that the vehicle 100 is not in the dangerous state and instructs the vehicle anti-theft method 400 to return to the detecting step S02 to continue detecting abnormalities with the camera 122.

The vehicle anti-theft method 400 can further include a reporting step S05. When the vehicle 100 is in the dangerous state, the communication device of the vehicle anti-theft system 300 is used by the monitoring personnel to notify the police and transmit the positioning coordinates to the police, enabling real-time collaboration with the police to protect the vehicle 100 from theft.

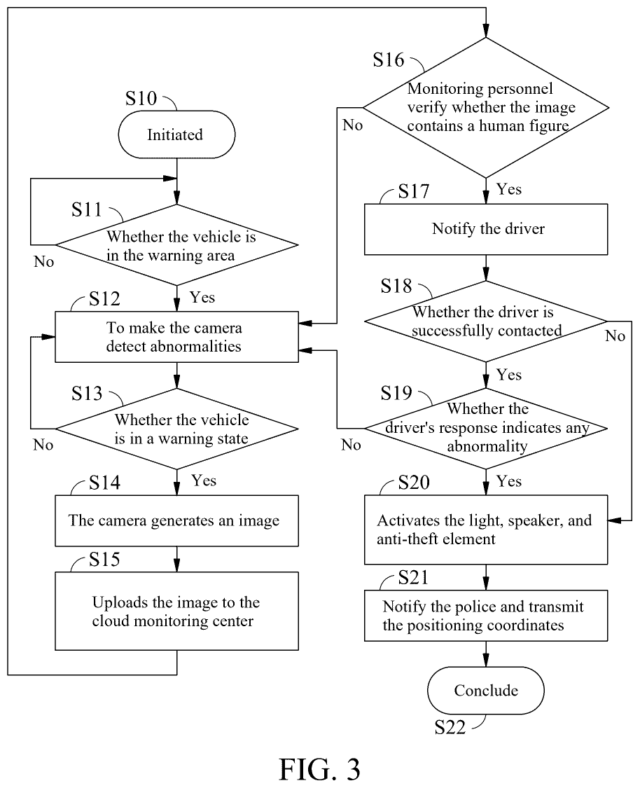

Please refer to FIG. 3, and also refer to FIG. 1 and FIG. 2. FIG. 3 illustrates a flowchart of the vehicle anti-theft method 400 of the embodiment shown in FIG. 2. In step S10, the vehicle anti-theft method 400 is initiated, and the positioning module 111 generates the positioning coordinates. Accordingly, the process moves to step S11, where the tracking processor 112 compares the positioning coordinates with the electronic fence coordinate area to determine whether the vehicle 100 is in the warning area. If the tracking processor 112 determines that the vehicle 100 is not in the warning area, continuous monitoring of whether the vehicle 100 enters the warning area is performed. Conversely, when the vehicle 100 enters the warning area, the process proceeds to step S12, where the tracking processor 112 notifies the photographing processor 121 to make the camera 122 detect abnormalities, and during this period, the camera 122 may continuously perform photographing. Subsequently, the process moves to step S13, where the recognition unit of the photographing processor 121 determines whether the image captured by the camera 122 contains the human figure, thereby determining whether the vehicle 100 is in the warning state. If the recognition unit determines that the image does not contain the human figure, the process returns to step S12 to continue the abnormality detection by the camera 122. On the other hand, if the recognition unit determines that the image contains the human figure, the vehicle 100 is considered to be in the warning state, and the process proceeds to step S14. The camera 122 generates the image and transmits it to the tracking processor 112. In step S15, the tracking processor 112 uploads the image to the cloud monitoring center 200 via the vehicle network module 114.

In step S16, the cloud monitoring center 200 receives data from the vehicle network module 114 via the monitoring network module 230 and displays the image through the display module 220. The monitoring personnel verify whether the image contains a human figure. If the monitoring personnel determine that the image does not contain the human figure, it indicates that the recognition module has misjudged, and the process returns to step S12 to continue the abnormality detection by the camera 122. Conversely, if the monitoring personnel determine that the image contains the human figure, the process proceeds to step S17, where the monitoring personnel use the communication device to notify the driver and proceed to step S18 to verify whether the driver is successfully contacted. If the driver is contacted, the process moves to step S19 to determine whether the driver's response indicates any abnormality. If the driver reports no abnormality, the process returns to step S12 to continue abnormality detection by the camera 122. If, in step S19, the driver reports an abnormal condition or if the driver cannot be contacted in step S17, the process proceeds to step S20. The cloud monitoring center 200 determines that the vehicle 100 is in the dangerous state. The monitoring processor 210 of the cloud monitoring center 200 activates the light 115, the speaker 116, and the anti-theft element 124 through the tracking processor 112 and the photographing processor 121. Subsequently, the process proceeds to step S21, where the monitoring personnel notify the police and transmit the positioning coordinates. Finally, the process moves to step S22 to conclude the vehicle anti-theft method 400.

In summary, the present disclosure has the following advantages: 1. The positioning coordinates of the vehicle can be obtained through the positioning module, and by comparing the positioning coordinates with the electronic fence coordinate area, it can be determined whether the vehicle is located in the safe area. 2. Through allowing the verification by the monitoring personnel and the driver, the probability of the vehicle anti-theft system misjudging the vehicle status can be reduced.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A vehicle anti-theft system, comprising:
a vehicle, comprising:
a tracker, comprising:
a positioning module configured to generate a plurality of positioning coordinates; and
a tracking processor signal-connected to the positioning module and configured to store an electronic fence coordinate area, wherein the tracking processor compares the positioning coordinates with the electronic fence coordinate area to determine whether the vehicle is in a safe area or a warning area, determines that the vehicle is in the safe area when the vehicle is within the electronic fence coordinate area, and determines that the vehicle is in the warning area when the vehicle is outside the electronic fence coordinate area; and
a photographing device, comprising:
a photographing processor signal-connected to the tracking processor; and
a camera signal-connected to the photographing processor and configured to obtain at least one of an image and a sound; and
a cloud monitoring center signal-connected to the tracking processor and configured to receive the positioning coordinates;
wherein when the tracking processor determines that the vehicle is in the warning area, the tracking processor notifies the photographing processor, the photographing processor causes the camera to obtain at least one of the image and the sound, and the photographing processor determines whether the vehicle is in a warning state or a safe state based on at least one of the image and the sound.

2. The vehicle anti-theft system according to claim 1, wherein the positioning module comprises a GPS receiving unit, the GPS receiving unit is signal-connected to the tracking processor and configured to generate the positioning coordinates.

3. The vehicle anti-theft system according to claim 1, wherein the photographing processor comprises a recognition unit, the recognition unit is configured to analyze the image and determines whether the image contains a human figure; if the image contains the human figure, the photographing processor determines that the vehicle is in the warning state, and the photographing processor uploads the image to the cloud monitoring center through the tracking processor.

4. The vehicle anti-theft system according to claim 3, wherein the photographing device further comprises a photographing Bluetooth transceiver module, the photographing Bluetooth transceiver module is connected to the photographing processor, and the tracker further comprises a tracking Bluetooth transceiver module, the tracking Bluetooth transceiver module is connected to the tracking processor, and the photographing Bluetooth transceiver module is signal-connected to the tracking Bluetooth transceiver module to achieve wireless transmission.

5. The vehicle anti-theft system according to claim 3, wherein the cloud monitoring center comprises a monitoring processor and a display module, the monitoring processor is signal-connected to the tracking processor, and the display module is signal-connected to the monitoring processor and configured to display the image.

6. The vehicle anti-theft system according to claim 5, further comprising a communication device, wherein the display module is configured to enable a monitoring personnel to verify whether the image indeed contains the human figure, and if the presence of the human figure is confirmed, the monitoring personnel uses the communication device to notify a driver.

7. The vehicle anti-theft system according to claim 6, wherein the photographing device further comprises an anti-theft element, the anti-theft element is signal-connected to the photographing processor, and if the driver does not respond or reports an abnormal condition, the cloud monitoring center determines that the vehicle is in a dangerous state, and the tracking processor notifies the photographing processor to activate the anti-theft element.

8. The vehicle anti-theft system according to claim 7, wherein when the cloud monitoring center determines that the vehicle is in the safe state or the warning state, the tracking processor reports the positioning coordinates to the monitoring processor at a first frequency; and when the vehicle is in the dangerous state, the tracking processor reports the positioning coordinates to the monitoring processor at a second frequency, wherein the first frequency is lower than the second frequency.

9. The vehicle anti-theft system according to claim 7, wherein when the cloud monitoring center determines that the vehicle is in the dangerous state, the communication device is configured to allow the monitoring personnel to notify the police and transmit the positioning coordinates to the police.

10. A vehicle anti-theft method, comprising:
an initial tracking step in which a vehicle anti-theft system generates a plurality of positioning coordinates, wherein the vehicle anti-theft system comprises a vehicle and a cloud monitoring center, the vehicle comprises a tracker and a photographing device, the tracker comprises a positioning module and a tracking processor, the positioning module is configured to generate the positioning coordinates, the tracking processor is signal-connected to the positioning module and stores an electronic fence coordinate area, the tracking processor compares the positioning coordinates with the electronic fence coordinate area to determine whether the vehicle is in a safe area or a warning area, the tracking processor determines that the vehicle is in the safe area when the vehicle is within the electronic fence coordinate area, and determines that the vehicle is in the warning area when the vehicle is outside the electronic fence coordinate area, the photographing device comprises a photographing processor and a camera, the photographing processor is signal-connected to the tracking processor, and the camera is signal-connected to the photographing processor and configured to obtain at least one of an image and a sound, and the cloud monitoring center is signal-connected to the tracking processor and configured to receive the positioning coordinates;
a detecting step in which when the tracking processor determines that the vehicle is in the warning area, the tracking processor notifies the photographing processor, the photographing processor causes the camera to obtain at least one of the image and the sound, and the photographing processor determines whether the vehicle is in a warning state or a safe state based on at least one of the image and the sound; and
an uploading step in which the photographing processor determines whether the vehicle is in the warning state based on at least one of the image and the sound, and the tracking processor uploads at least one of the image and the sound to the cloud monitoring center.

11. The vehicle anti-theft method according to claim 10, wherein the positioning module comprises a GPS receiving unit, and in the initial tracking step, the GPS receiving unit is signal-connected to the tracking processor and configured to generate the positioning coordinates.

12. The vehicle anti-theft method according to claim 10, wherein the photographing processor comprises a recognition unit, and in the detecting step, the recognition unit analyzes the image to determine whether the image contains a human figure; if the image contains the human figure, the photographing processor determines that the vehicle is in the warning state, and in the uploading step, the photographing processor uploads the image to the cloud monitoring center through the tracking processor.

13. The vehicle anti-theft method according to claim 12, wherein the photographing device further comprises a photographing Bluetooth transceiver module, the photographing Bluetooth transceiver module is connected to the photographing processor, the tracker further comprises a tracking Bluetooth transceiver module, the tracking Bluetooth transceiver module is connected to the tracking processor, and the photographing Bluetooth transceiver module is signal-connected to the tracking Bluetooth transceiver module, and in the uploading step, the photographing Bluetooth transceiver module transmits at least one of the image and the sound to the tracking Bluetooth transceiver module to achieve wireless transmission, and the tracking processor further uploads the image to the cloud monitoring center.

14. The vehicle anti-theft method according to claim 12, wherein the cloud monitoring center comprises a monitoring processor and a display module, the monitoring processor is signal-connected to the tracking processor, and the display module is signal-connected to the monitoring processor, the vehicle anti-theft method further comprises a confirmation step, wherein in the confirmation step, the display module displays the image for verification by a monitoring personnel.

15. The vehicle anti-theft method according to claim 14, wherein in the confirmation step, the monitoring personnel verify whether the image indeed contains the human figure, and if the presence of the human figure is confirmed, the monitoring personnel notify a driver.

16. The vehicle anti-theft method according to claim 15, wherein the photographing device further comprises an anti-theft element, the anti-theft element is signal-connected to the photographing processor, and in the confirmation step, if the driver does not respond or reports an abnormal condition, the cloud monitoring center determines that the vehicle is in a dangerous state, and the tracking processor notifies the photographing processor to activate the anti-theft element.

17. The vehicle anti-theft method according to claim 15, wherein the tracking processor further comprises a speaker and a light, the speaker and the light are signal-connected to the tracking processor, and in the confirmation step, if the driver does not respond or reports an abnormal condition, the cloud monitoring center determines that the vehicle is in a dangerous state, and the tracking processor activates the speaker and the light.

18. The vehicle anti-theft method according to claim 17, wherein in the confirmation step, if the cloud monitoring center determines that the vehicle is in the safe state or the warning state, the tracking processor, in the uploading step, reports the positioning coordinates to the monitoring processor at a first frequency; and if the cloud monitoring center determines that the vehicle is in the dangerous state, the tracking processor, in the uploading step, reports the positioning coordinates to the monitoring processor at a second frequency, wherein the first frequency is lower than the second frequency.

19. The vehicle anti-theft method according to claim 17, further comprising a reporting step, wherein when the vehicle is in the dangerous state, a communication device of the vehicle anti-theft system is configured to allow the monitoring personnel to notify the police and transmit the positioning coordinates to the police.

20. The vehicle anti-theft method according to claim 15, wherein in the confirmation step, if the driver reports no abnormal condition, the cloud monitoring center determines that the vehicle is not in a dangerous state and instructs the vehicle anti-theft method to return to the detecting step.
